(19) United States
(12) Patent Application Publication
(10) Pub. No.: US 2015/0101237 A1
(43) Pub. Date: Apr. 16, 2015

(54) JOINTED FISHING HOOK

(71) Applicant: David William Bedore, Brandon, MN (US)

(72) Inventor: David William Bedore, Brandon, MN (US)

(21) Appl. No.: 14/515,179

(22) Filed: Oct. 15, 2014

Related U.S. Application Data
(60) Provisional application No. 61/961,394, filed on Oct. 15, 2013.

(51) Int. Cl. A01K 83/00; A01K 91/00

(52) U.S. Cl. CPC A01K 83/00; A01K 91/00
USPC 43/43.16; 43/4.5

(57) ABSTRACT

A jointed fishing hook is provided. The jointed fishing hook includes a top shank and a bottom shank. The top shank includes a first end and a second end. The first end of the top shank forms a first eye. The bottom shank includes a first end and a second end. The second end of the bottom shank includes a bend forming a hook. The second end of the top shank is pivotally connected to the first end of the bottom shank. Therefore, the bottom shank may freely move relative to the top shank.

### CROSS-REFERENCE TO RELATED APPLICATION

This application claims the benefit of priority of U.S. provisional application No. 61/961,394, filed Oct. 15, 2013, the contents of which are herein incorporated by reference.

### BACKGROUND OF THE INVENTION

The present invention relates to a fishing hook and, more particularly, to a jointed fishing hook.

A fish hook is a device for catching fish by impaling them in the mouth. Fish hooks are normally attached to some form of line or lure device which connects the caught fish to the fisherman. There is an enormous variety of fish hooks in the world of fishing. Sizes, designs, shapes, and materials are all variable depending on the intended purpose of the fish hook. Fish hooks are manufactured for a range of purposes from general fishing to extremely limited and specialized applications. Fish hooks are designed to hold various types of artificial, processed, dead or live baits; to act as the foundation for artificial representations of fish prey; or to be attached to or integrated into other devices that represent fish prey. Currently, fish hooks do not move independently of the line to which they are attached. Therefore, any bait that is attached to the hook only moves with the line, which does not present a realistic look.

As can be seen, there is a need for a device that facilitates independent movement of the bait and hook.

### SUMMARY OF THE INVENTION

In one aspect of the present invention, a jointed fishing hook comprises: a top shank comprising a first end and a second end, wherein the first end forms a first eye; and a bottom shank comprising a first end and a second end, wherein the second end comprises a bend forming a hook, wherein the second end of the top shank is pivotally connected to the first end of the bottom shank.

In another aspect of the present invention, a method of preparing a jointed fishing hook comprises: providing a top shank comprising a first end and a second end, wherein the first end forms a first eye; providing a bottom shank comprising a first end and a second end, wherein the second end comprises a bend forming a hook; and pivotally attaching the second end of the top shank to the first end of the bottom shank; and attaching a bait to the hook.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is a perspective view of the present invention;

FIG. 3 is a side view of the present invention illustrating the lateral movement of the bottom shank relative to the top shank;

FIG. 4 is a front view of the present invention illustrating the lateral movement of the bottom shank relative to the top shank;

FIG. 5 is a top view of the present invention illustrating the lateral movement of the bottom shank relative to the top shank; and

FIG. 6 is an enlarged perspective view illustrating an indeterminate length

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a fish hook that is jointed to allow the barbed hook to move in different directions. Utilizing the present invention, the hook is able to move left, right, up and down as it moves through the water. Therefore, the fish hook and bait of the present invention move independently of the line and allows a fish hook with live or artificial bait to move in a more natural manner. The present invention may be made of two parts. The two parts may include a fishing hook and a top shank pivotally connected. The parts may be made of a rust-resistant, rigid, round, flat, square or triangular material such as metal, plastic, wood or any composite material and includes small, medium or heavy weights.

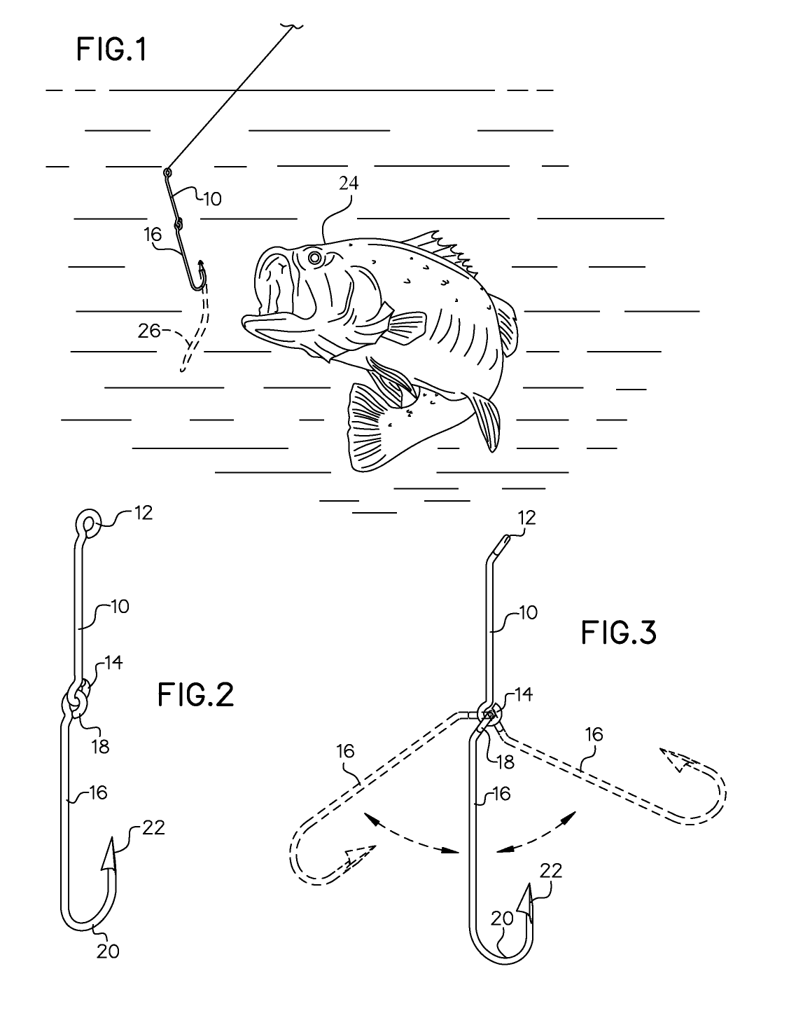

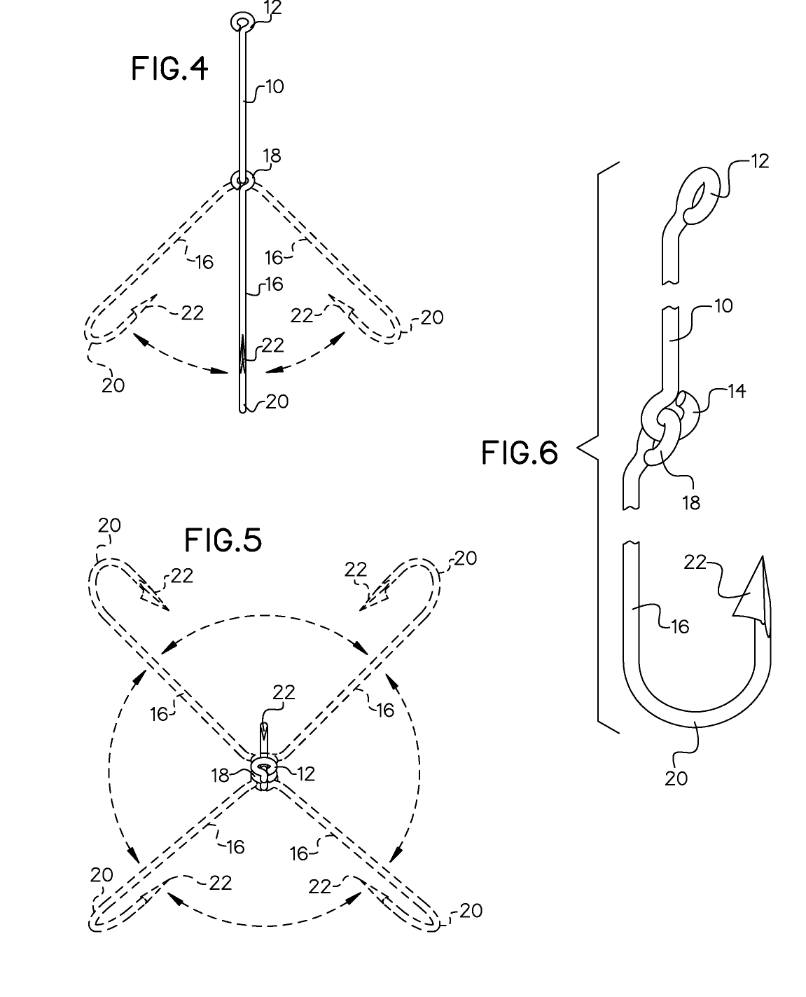

Referring to FIGS. 1 and 6, the present invention includes a jointed fishing hook. The jointed fishing hook includes a top shank 10 and a bottom shank 16. The top shank 10 includes a first end and a second end. The first end of the top shank 10 forms a first eye 12. The bottom shank 16 includes a first end and a second end. The second end of the bottom shank 16 includes a bend 20 forming a hook. The second end of the top shank 10 is pivotally connected to the first end of the bottom shank 16. Therefore, the bottom shank 16 may freely move relative to the top shank 10.

In certain embodiments, the top shank 10 and the bottom shank 16 may be connected together by additional eyes 14, 18. In such embodiments, the first end of the bottom shank 16 may form a hook eye 18 and the second end of the top shank 10 may form a second eye 14. The second eye 14 and the hook eye 18 may be linked together to form the pivotal connection of the jointed fishing hook.

The top shank 10 of the present invention may include a substantially straight length of material, ranging in length from about ¼ of an inch to 3 inches. The first eye 12 and the second eye 14 may be round openings on each end. The openings may be formed by bending the end of the top shank 10 in such a manner as to form a circle-like shape. The round opening may also be formed by attaching a circle of material to the top of the top shank 10 by solder, welding, brazing, gluing, compressing, wiring, tying or using an interior or exterior thread to attach the circle. The outside diameter of the eyes 12, 14 of the top shank 10 may be approximately 0.01-0.30 inches. The fishing line may be attached to the first eye 12 of the top shank 10.

The bottom shank 16 of the present invention may be a small, medium or large hook, ranging in length from ½ inch to 3 inches. The top of the straight length of the bottom shank 16 may include the hook eye 18, which is a round opening. The opening may be formed by bending the end of the material in such a manner as to form a circle-like shape at the top of the bottom shank 16. The round opening may also be formed by attaching a circle of material to the top of the hook shank by solder, welding, brazing, gluing, compressing, wiring, tying or using an interior or exterior thread to attach the circle. The outside diameter of the hook eye 16 of the bottom shank 16 may be approximately 0.01-0.30 inches. The bottom shank 16 of the present invention includes a bend 20 creating a hook. The end of the hook is tapered to a point and may or may not contain a barb 22, which is a slight separation of the material from the main part of the material creating a space between the barb and the material. The bait 26 may be attached to the hook to lure the fish 24.

The second eye 14 of the top shank 10 is connected in a manner that allows a 0.01 to 0.15 inch clearance between the material used to create the eye 14 at the bottom of the top shank 10 and the material used to create the hook eye 18 of the bottom shank 16. When the present invention is assembled it allows the hook to move freely up and down, left and right and at random angles no less than 100 degrees of a circle.

The present invention includes a method of preparing a jointed fishing hook. The method includes: providing the top shank described above; providing the bottom shank described above; pivotally attaching the second end of the top shank to the first end of the bottom shank; and attaching a bait to the hook. When the first end of the bottom shank forms a hook eye, and the second end of the top shank forms a second eye, the method further includes the step of pivotally attaching the second end of the top shank to the first end of the fish hook by linking the hook eye and the second eye together. The method may further include the step of attaching a fishing line to the first eye of the top shank.

It should be understood, of course, that the foregoing relates to exemplary embodiments of the invention and that modifications may be made without departing from the spirit and scope of the invention as set forth in the following claims.

What is claimed is:

1. A jointed fishing hook comprising:
a top shank comprising a first end and a second end, wherein the first end forms a first eye; and
a bottom shank comprising a first end and a second end, wherein the second end comprises a bend forming a hook,
wherein the second end of the top shank is pivotally connected to the first end of the bottom shank.

2. The jointed fishing hook of claim 1, wherein the first end of the bottom shank forms a hook eye, and the second end of the top shank forms a second eye, wherein the hook eye and the second eye are linked to form a pivotal connection.

3. The jointed fishing hook of claim 1, wherein the second end of the bottom shank further comprises a point and a barb.

4. The jointed fishing hook of claim 1, further comprising a fishing line attached to the first eye of the top shank.

5. The jointed fishing hook of claim 1, wherein the top shank is substantially straight.

6. The jointed fishing hook of claim 1, wherein the top shank is about ¼ of an inch up to about 3 inches in length.

7. A method of preparing a jointed fishing hook comprising:
providing a top shank comprising a first end and a second end, wherein the first end forms a first eye;
providing a bottom shank comprising a first end and a second end, wherein the second end comprises a bend forming a hook;
pivotally attaching the second end of the top shank to the first end of the bottom shank; and
attaching a bait to the hook.

8. The method of claim 7, wherein the first end of the bottom shank forms a hook eye, and the second end of the top shank forms a second eye, wherein pivotally attaching the second end of the top shank to the first end of the bottom shank comprises linking the hook eye and the second eye together.

9. The method of claim 7, wherein the second end of the bottom shank further comprises a point and a barb

10. The method of claim 7, further comprising the step of attaching a fishing line to the first eye of the top shank.

11. The method of claim 7, wherein the top shank is substantially straight.

12. The method of claim 7, wherein the top shank is about ¼ of an inch up to about 3 inches in length.
